(19) United States
(12) Patent Application Publication
(10) Pub. No.: US 2008/0011486 A1
(43) Pub. Date: Jan. 17, 2008

(54) BIODEGRADABLE FOAM COMPOSITIONS FOR OIL FIELD OPERATIONS

(76) Inventors: Kewei Zhang, Calgary (CA); Brent Ritten, Calgary (CA)

Correspondence Address: DUNLAP CODDING & ROGERS, P.C., PO BOX 16370, OKLAHOMA CITY, OK, 73113, US

(21) Appl. No.: 11/774,436

(22) Filed: Jul. 6, 2007

Related U.S. Application Data
(60) Provisional application No. 60/818,532, filed on Jul. 6, 2006.

(51) Int. Cl. E21B 43/26; C09K 8/62

(52) U.S. Cl. 166/308.6; 507/209

(57) ABSTRACT

Biodegradable foam compositions for oil field operations including drilling, hydraulic fracturing and wellbore cleanout are disclosed. The compositions comprise an aqueous liquid, an alkyl polyglucoside surfactant and a gas.

### CROSS-REFERENCE TO RELATED APPLICATIONS

This application claims the benefit of priority from U.S. Provisional Application Ser. No. 60/818,532 filed on Jul. 6, 2006, the contents of which are hereby incorporated herein by reference in their entirety.

### FIELD OF THE INVENTION

The present invention relates to foam compositions useful in different oil field operations, including particularly hydraulic fracturing, drilling and wellbore cleanout operations.

### BACKGROUND

In oil field operations including drilling and hydraulic fracturing, water-based foam fluids are widely used. The fluids contain essentially an aqueous liquid, a foaming surfactant and a gas. Optionally a water-soluble polymer is also added to increase foam stability. Normally the foaming surfactant is selected from a group comprising of anionic, amphoteric and cationic surfactants. The aqueous liquids include fresh or sea water, brines and water containing small amounts of alcohols. The gas includes nitrogen, carbon dioxide and air. The polymers include either synthetic polymers, for example polyacrylamide and polyethylene oxides, or natural polymers, also known as biopolymers. Typical examples of biopolymers include guar gum, guar gum derivatives such as hydroxypropyl guars, xanthan gum and various modified celluloses. Foam fluids usually are less expansive, have low fluid leak and cause less damage to formations. Unfortunately, most of foaming surfactants currently used in oil field operations are not readily biodegradable and ecological incompatible and therefore present a toxic hazard to environment. The environmental impacts of surfactants become more paramount when they are used in shallow formations such as shallow sandstones and coal seams and offshore operations. Generally, the environmental fate of surfactants is inextricably linked with their biodegradation behavior because biodegradation is the foremost mechanism for the ultimate elimination of chemical substances from aquatic and terrestrial environments. Thus, quick and complete biodegradability is the most important requirement for an environmentally compatible surfactant. Thus it is highly desirable to have a foaming fluid which has comparable physiochemical properties as conventional foaming fluid but is readily biodegradable and has no harmful effects on the environment.

### SUMMARY

In one aspect, the present invention relates to a well service fluid composition comprising an alkyl polyglucoside surfactant and, an aqueous liquid. The fluid composition can be foamed with a gas. The alkyl polyglucoside can have the molecular structure: 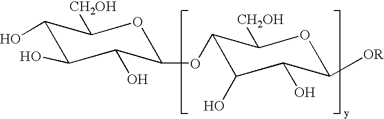
where y=0-5, and R is a carbon chain containing 6 to 24 carbon atoms. R can also be an alkyl chain containing 8 to 16 carbon atoms. The well service fluid can further include a water-soluble polymer. The polymer can be selected from the group consisting of guar gum, guar gum derivatives and modified cellulose. The well service fluid can further include a proppent.

In another aspect, the present invention relates to a well service fluid comprising an alkyl polyglucoside surfactant, an aqueous liquid and a gas.

In another aspect, the present invention relates to water-based biodegradable foam compositions comprising an aqueous liquid and an alkyl polyglucoside surfactant and a gas suitable for oil field operations including drilling, hydraulic fracturing and wellbore cleanout.

In another aspect, the present invention relates to a method of fracturing a subterranean formation using a fracturing fluid, comprising:

(a) providing a concentrate at the ground surface, the concentrate comprising an effective amount of an alkyl polyglucoside,

(b) providing an aqueous fluid component;

(c) blending the concentrate with the aqueous fluid component to form a fracturing fluid and pumping the viscous fracturing fluid into a wellbore.

The fluid can be foamed.

### DETAILED DESCRIPTION

In one aspect of the present invention, alkyl polyglucosides (APGs) surfactants are used to replace conventional foaming surfactants used in oil field operations to make environment-friendly foaming fluids for oil field operations. APGs are a type of nonionic sugar-based surfactants, which are synthesized by direct reaction of glucose with fatty alcohol. Alternatively APGs can be made by enzymatic synthesis. Preferably, APGs have the following molecular structure: 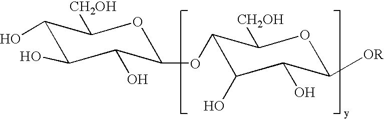
where y=0-5, and R is a carbon chain containing 6 to 24 carbon atoms. Preferably, R is an alkyl chain containing 8 to 16 carbon atoms.

APGs have been used mainly in cosmetics and household formulations. APGs have favorable environmental profile: excellent biodegradability in that they are ultimately biodegradable to water and carbon dioxide under all environmental conditions and have no aquatic and terrestrial toxicity. In particular, APGs with high HLB values, for example, ranging from 11 to 16, are readily soluble in water and have high foaming capability. In addition, unlike conventional nonionic surfactants used in oil field operations, APGs do not show the pronounced inverse solubility vs. temperature relationship, and have remarkably high salt tolerance. This provides additional advantages over normal nonionic surfactants especially when used in relative deep wells, where high temperature and high concentration brines are commonly encountered.

Preferably, the number of carbon atoms in the alkyl chain of APGs ranges from 8 to 16. Typical examples of APGs useful for the present invention include TRITON BG-10 (Dow Chemicals), TRITON CG-110 (Dow Chemicals), APG 325 (Henkel), APG 600 (Henkel), Glucopon (Henkel) and AI 2575 (ICI). Optionally, a water-soluble polymer can be included in the foam compositions at the concentration from about 0.1 kg/m3 to 1 kg/m3. Biopolymers including guar gum and various modified celluloses are preferred, due to their environmental benign properties. The concentration of APGs in the foam composition typically varies from about 0.1 L/m3 to 10 L/m3.

During drilling or fracturing operations, the APG can be directly mixed into an aqueous liquid and then mixed with certain amount of gas while pumping the fluid into a well. The quality of the foam typically ranges from about 20% to 75%. Optional, in some operations a water-soluble polymer is added into the fluid to further enhance the foam stability. The fluid can be either batch or on-the-fly mixed. In drilling operations, the foam fluid is circulated through the wellbore and transport the cutting out of well. For example, during a hydraulic fracturing process desirable amount of TRITON CG-10 surfactant and slurry containing 50% of guar gum can be mixed on-the-fly into aqueous liquid and then mixed with nitrogen gas while pumping into the well to generate foaming fluid with high quality and stability. For hydraulic fracturing, proppants are normally transported into the fracture with the foam fluid after the fracture is initiated. Different APGs can be used together in the applications. Optionally normal foaming surfactants can be combined with APGs in the composition. Similarly, in wellbore cleanout operations, the foam fluid can be circulated through the wellbore at a rate sufficient to carry the debris out the well bore.

The following examples serve to illustrate the concepts of the present invention.

### EXAMPLES

To test the foaming ability and the stability of the foam, the foam volume and the half-life of the foam was measured. The aqueous fluids were tap water and 5% KCl water, respectively. The biodegradable foaming surfactants used in the tests were TRITON BG-10 (Dow Chemicals) and TRITON CG-110 (Dow Chemicals). For comparison, foaming composition containing biopolymer, hydroxyethylcellulose (HEC-10) and guar gum, respectively, were also tested.

200 mL of fluid was placed in a 1 L beaker. Desirable amount of the additives was added to the fluid. The fluid was foamed with a hand-held mixer for two minutes, and the total volume of the foam and the half-life of the foam were measured. The half-life of the foam is the time required when half volume of the total liquid is accumulated on the bottom of the beaker. The testing results are listed in Table 1.

TABLE 1

| Aqueous | Polymer | Surfactant | Fluid | Total | Foam | Half-Life |
|---|---|---|---|---|---|---|
| Fluid | 1 kg/m³ | 2 L/m³ | Volume(mL) | Volume(mL) | Volume(%) | (min:sec) |
| water | none | BG-10 | 200 | 700 | 71 | 0.05208 |
| water | none | CG-110 | 200 | 700 | 71 | 0.04861 |
| 5% KCl | none | BG-10 | 200 | 700 | 71 | 0.05208 |
| 5% KCl | none | CG-110 | 200 | 700 | 71 | 0.04167 |
| water | HEC | BG-10 | 200 | 680 | 71 | 0.375 |
| water | HEC | CG-110 | 200 | 680 | 71 | 0.347222 |
| 5% KCl | HEC | BG-10 | 200 | 650 | 69 | 0.347222 |
| 5% KCl | HEC | CG-110 | 200 | 680 | 71 | 0.347222 |
| water | Guar | BG-10 | 200 | 680 | 71 | 0.354167 |
| water | Guar | CG-110 | 200 | 680 | 71 | 0.354167 |
| 5% KCl | Guar | BG-10 | 200 | 680 | 71 | 0.354167 |

*Tests were run at room temperature 22° C.

From Table 1, it is clear that the biodegradable foaming surfactants have good foaming capability in the aqueous fluids and the foam formed has good stability. Moreover, adding biopolymer in the fluid further enhances the foam stability. These foaming fluid compositions can find many applications in oil field services including drilling hydraulic fracturing and wellbore cleaning.

What is claimed:

1 A well service fluid comprising an alkyl polyglucoside surfactant and, an aqueous liquid.

2. The well service fluid according to claim 1 wherein the alkyl polyglucoside has the molecular structure: 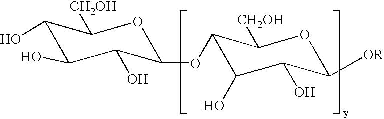
where y=0-5, and R is a carbon chain containing 6 to 24 carbon atoms.

3. The well service fluid according to claim 2 wherein R is an alkyl chain containing 8 to 16 carbon atoms.

4. The well service fluid according to claim 1 further including a water-soluble polymer.

5. The well service fluid according to claim 4 wherein the polymer is selected from the group consisting of guar gum, guar gum derivatives and modified cellulose.

6. The well service fluid according to claim 1 further including a proppent.

7. A foamed well service fluid comprising an alkyl polyglucoside surfactant, an aqueous liquid and a gas.

8. The foamed well service fluid according to claim 1 wherein the alkyl polyglucoside has the molecular structure: 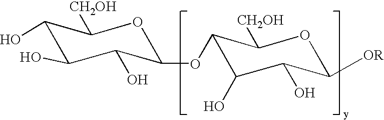
where y=0-5, and R is a carbon chain containing 6 to 24 carbon atoms.

9. The foamed well service fluid according to claim 8 wherein R is an alkyl chain containing 8 to 16 carbon atoms.

10. The foamed well service fluid according to claim 8 wherein the gas is selected from the group consisting of nitrogen, carbon dioxide and air.

11. The foamed well service fluid according to claim 10 further including a water-soluble polymer.

12. The foamed well service fluid according to claim 11 wherein the polymer is selected from the group consisting of guar gum, guar gum derivatives and modified cellulose.

13. The foamed well service fluid composition according to claim 7 further including a proppant.

14. A method of fracturing a subterranean formation using a fracturing fluid, comprising:
providing a concentrate at the ground surface, the concentrate comprising an effective amount of an alkyl polyglucoside, providing an aqueous fluid component;
blending the concentrate with the aqueous fluid component to form a fracturing fluid and pumping the viscous fracturing fluid into a wellbore.

15. The method according to claim 14 wherein the concentrate is blended with the aqueous fluid component to form a fracturing fluid while pumping the fracturing fluid into a wellbore.

16. The method according to claim 15 wherein the alkyl polyglucoside has the molecular structure: 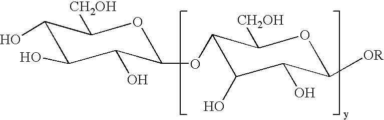
where y=0-5, and R is a carbon chain containing 6 to 24 carbon atoms.

17. The method according to claim 16 wherein R is an alkyl claim containing 8 to 16 carbon atoms.

18. The method according to claim 14 wherein the fluid is foamed with a gas.

19. The method according to claim 18 wherein the gas is selected from the group comprising nitrogen, carbon dioxide and air.

20. The method according to claim 18 wherein the foamed fluid further includes a water-soluble polymer.

21. The method according to claim 20 wherein the polymer is selected from the group comprising guar gum, guar gum derivatives and modified cellulose.

22. The method according to claim 18 wherein the fluid further includes a proppant.
